(19) United States
(12) Patent Application Publication
(10) Pub. No.: US 2026/0035515 A1
(43) Pub. Date: Feb. 5, 2026

(54) SURFACE ADDITIVE BASED ON POLYSILOXANE MODIFIED UNSATURATED POLYESTER

(71) Applicant: BYK-Chemie GmbH, Wesel (DE)

(72) Inventors: Majdi Al-Masri, Alpen (DE); Timo Kettmann, Wesel (DE); Volker Thyssen-Wallner, Goch (DE)

(21) Appl. No.: 18/997,241

(22) PCT Filed: Jul. 20, 2023
(86) PCT No.: PCT/EP2023/025341

§ 371 Date: Jan. 21, 2025

(30) Foreign Application Priority Data
Jul. 21, 2022 (EP) 22186250.1

(51) Int. Cl. C08G 77/445; C09D 4/06; C09D 7/20; C09D 7/47; C09D 133/06

(52) U.S. Cl. CPC C08G 77/445; C09D 4/06; C09D 7/20; C09D 7/47; C09D 133/066

(57) ABSTRACT

A polymer comprising a polymer backbone comprising a polyester segment S1, which comprises at least one unit according to formula (I) wherein R¹ is an aromatic or aliphatic, saturated or unsaturated group consisting of elements selected from C, H, O, R² is an aromatic or aliphatic, saturated or unsaturated group consisting of elements selected from C, H, O, X comprises at least one of OH, (C═O)OH, O—(C═O)CH₃, O—(C═O)C(CH₃)═CH₂ and O—(C═O)CH═CH₂, wherein the polyester segment S1 comprises at least one ethylenically unsaturated group, which is different from X and at least one polysiloxane segment S2.

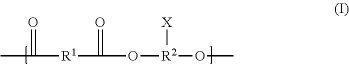

The invention relates to a polymer comprising a polymer backbone comprising a polyester segment and at least one polysiloxane segment. Furthermore, the invention relates to a process for preparing the polyester segment, the use of the polymer as an additive for controlling the surface properties of a composition or an object and a composition comprising the polymer and one or more diluents.

Additives are used to modify the surface properties of thermoplastics, coating, and moulding compositions. These characteristics comprise enhancing the spreadability and slip, scratch resistance, anti-fingerprint, easy-to-clean properties, and the avoidance of defects amongst others. To adapt the surface properties polyester-modified polysiloxanes are employed, as described in EP 0 175 092 B1. The document describes how polyester-modified siloxanes are used to increase the scratch resistance and slip of coating materials and moulding compounds. The polyester modified polysiloxanes are branched with polyester moieties in the side chains. Repeating the syntheses described in example 9 and 10 which deals with the polycondensation of polyesters by using hydroxyl terminated polysiloxane as reactant did not proceed as described in the document. An acid value of 0.7 was not achievable and the NMR analyses show that the polysiloxanes chain was partially decomposed after the distillations at 200° C. Cyclic and linear PDMS oligomers were formed.

U.S. Pat. No. 5,177,160 A describes the syntheses of an organopolysiloxane graft-type polyester made of aromatic diacid chloride and diols in the presence of a base. No functional groups were mentioned in this invention and the syntheses route described does not allow the syntheses of instant pendant hydroxy functional groups.

To comply with numerous requirements regarding surface properties in different kinds of application systems, there is an ongoing need to synthesize polyester modified polysiloxanes according to the respective demands. Generally, polyester-modified polysiloxanes are manufactured by ring-opening polymerization of lactones, such as propiolactone, caprolactone, valerolactone or dodecalactone. This inevitably leads to a lack of variety with regard to synthesis possibilities, resulting in a limited variation of polarity, compounds and a limited system compatibility. Moreover, ring-opening polymerization of lactones leads mostly to solid products. Therefore, significant quantities of solvents are needed to dilute the compounds and obtain a liquid additive.

The polycondensation of free di-carboxylic acid and compounds having at least two hydroxyl groups on the other hand is easy to control and exhibit more selectivity. No separation step is required, and no salt is formed as in the case of U.S. Pat. No. 5,177,160 A. Additional functional pendant groups allow the polymer to be impeded in the coating matrix. In addition, polar pendant functional groups in silicon containing additives could be a viable alternative to the perfluorinated polyether-based additives, which are unfavorable because of their negative environment impact and the high price.

Thus, it is a particular object of the invention to provide a polyester polymer which can be modified according to the specific demands of the respective application. Furthermore, it is an object of the invention to provide a polyester polymer in liquid as well as in solid form which is employable in numerous application systems. A further object is to provide a polyester polymer which leads to improved permanent easy-to-clean-properties in the applied coating systems. Another object of the invention is to provide a polyester polymer which exhibits low migration in the application system. An even further object of the invention is to provide thermally stable organomodified silicones.

Surprisingly, it has been found that these objectives can be achieved by the provision of a polymer comprising a polymer backbone comprising a polyester segment S1, which comprises at least one unit according to formula (I)

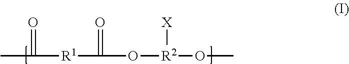

wherein
R¹ is an aromatic or aliphatic, saturated or unsaturated group consisting of elements selected from C, H, O,
R² is an aromatic or aliphatic, saturated or unsaturated group consisting of elements selected from C, H, O,
X comprises at least one of —OH, —(C═O)OH, —O—(C═O)CH₃, —O—(C═O)C(CH₃)═CH2 and —O—(C═O)CH═CH₂,
wherein the polyester segment S1 comprises at least one ethylenically unsaturated group, which is different from X,
and at least one polysiloxane segment S2.

The polymer backbone comprising a polyester segment S1 which comprises at least one repeating unit according to formula (I) may suitably be linear or branched. The at least one polysiloxane segment S2 may preferably be linked to the polymer backbone laterally, or, in another embodiment it may preferably be linked to the polymer backbone terminally, which means that it is bound to the end groups of the polymer backbone. In case that more than one polysiloxane segment S2 is present, the segments may preferably be bound laterally and/or terminally to the polymer backbone. Preferably, the polysiloxane segment S2 is linked covalently to the polyester segment S1. Suitably the polysiloxane segment S2 is linked laterally or terminally to the polyester segment S1.

It is preferred that R¹ is a hydrocarbyl group or a hydrocarbyl group interrupted by one or more ether groups and that R² is a hydrocarbyl group.

The term “hydrocarbyl group” denotes for an organic group that consists of carbon and hydrogen atoms only. The hydrocarbyl group represented by R¹ preferably has 2 to 22 carbon atoms, more preferably 2 to 16 carbon atoms, even more preferably 2 to 6 carbon atoms and the most preferably 3 to 4 carbon atoms. Suitably, R¹ is aliphatic, aliphatic aromatic or cycloaliphatic. It is also preferred that R¹ is a saturated or unsaturated aliphatic group. It is also preferred that R¹ is a linear aliphatic group.

The hydrocarbyl group represented by R² is a hydrocarbyl group having 2 to 12 carbon atoms. Preferably, R² is aliphatic, cycloaliphatic or aromatic.

Examples for suitable hydrocarbyl groups and hydrocarbyl groups interrupted by one or more ether groups are hydrocarbyl groups of compounds having at least two hydroxyl groups, suitably these compounds are diols or triols.

Preferably, the polyester segment S1 is obtainable by reacting triols and dicarboxylic acids or tricarboxylic acids and diols. Diols are chemical compounds containing two hydroxyl groups (—OH groups). Examples for suitable diols are 2,2-dimethyl-1,3-propandiol, 2-methyl-1,3-propandiol, 1, 3-propylene glycol, 1,6-hexanediol, ethylene glycol, diethylene glycol, triethylene glycol, propylene glycol, 1,3-butylene glycol, 2,4-pentylene glycol, 1,6-dianhydrosorbitol, 1,6-dianhydromannitol, 1,6-dianhydroiditol, 1,4-Bis(2-hydroxyethoxy)-benzene, 2,5-hexanediol. Moreover, mono-ols may be employed as well. Triols are chemical compounds containing three hydroxyl groups (—OH groups). Examples for suitable triols are glycerol, trimethylolpropane, butane-1,2,4-triol, butane-1,2,3,4-tetraol, hexane-1,2,3-triol, 1,2,7-Heptanetriol, 2-hydroxy-1,4-Benzenedimethanol.

Dicarboxylic acids are organic compounds containing two carboxyl functional groups (—COOH) and may be aliphatic or aromatic compounds. Examples for suitable dicarboxylic acids are maleic acid, fumaric acid, succinic acid, glutaric acid, adipic acid, acetylenedicarboxylic acid, glutaconic acid, traumatic acid, muconic acid, mesaconic acid, and the anhydrides thereof. Moreover, monocarboxylic acids may suitably be employed as well.

Tricarboxylic acids are organic compounds containing three carboxyl functional groups (—COOH) and may be aliphatic or aromatic compounds. Suitable examples for tricarboxylic acids are Propane-1,2,3-tricarboxylic acid, 1-Propene-1,2,3-tricarboxylic acid, Pentane-1,3,5-tricarboxylic acid, 2-hydroxypropane-1,2,3-tricarboxylic acid, 2-Hydroxynonadecane-1,2,3-tricarboxylic acid.

Compounds having two carboxylic acids and one or more hydroxyl groups, or two hydroxyl groups and one or more carboxylic acid group are suitable as well, for example isocitric acid, 2,2-bis(hydroxymethyl)propionic acid, 2,2-Bis(hydroxymethyl)butyric acid, 2-hydroxypropane-1,2,3-tricarboxylic acid, 3-hydroxybutane-1,2,3-tricarboxylic acid, agaric acid,

Additionally, xylitol, N-methyl diethanolamine, and any dicarboxylic acid or diols with additional secondary alcohol or acid groups or tertiary amine are suitable.

Suitably, by reacting compounds having at least two hydroxyl groups with dicarboxylic acid during a polycondensation reaction, the polyester segment S1 is formed.

X comprises at least one of —OH (hydroxyl group), —(C═O)OH (carboxylic acid group), —O—(C═O)CH₃ (acetate group), —O—(C═O)C(CH₃)═CH₂ (methacrylate group) and —O—(C═O)CH═CH₂ (acrylate group). These groups are also referred to as functional pendant groups in the context of this invention.

The polyester segment S1 comprises at least one ethylenically unsaturated group, which is different from X. It is preferred that the polyester backbone comprises ethylenically unsaturated groups, which are preferably introduced using ethylenically unsaturated monoalcohols, diols or triols. Generally, the ethylenically unsaturated groups may also be present in the form of electron rich double bonds, but also esters such as those from acrylic or maleic acid are suitable. Preferably, the double bonds are introduced by allylethers or by isoprenol.

Preferably, the at least one ethylenically unsaturated group is a terminal group, which means that the segment S1 comprising the at least one ethylenically unsaturated group represents the end group of the polymer. In a different embodiment, the at least on ethylenically unsaturated group preferably is a non-terminal group, which means that the unsaturation is not located at the end groups of the polymer. In this case the segment S1 comprising the at least one ethylenically unsaturated group is located within the polymer. In another preferred embodiment, the polymer comprises more than one ethylenically unsaturated group which are present as terminal and non-terminal groups.

It is preferred that the molar ratio of the at least one polysiloxane segment S2 and the ethylenically unsaturated group is in the range of 5:95 to 50:50. It is more preferred that the molar ratio of the at least one polysiloxane segment S2 and the ethylenically unsaturated group is in the range of 15:85 to 50:50. It is even more preferred that the molar ratio of the at least one polysiloxane segment S2 and the ethylenically unsaturated group is in the range of 25:75 to 50:50 and most preferred that the molar ratio is in the range of 35:65 to 50:50.

In a further embodiment, the molar ratio of the at least one polysiloxane segment S2 and the ethylenically unsaturated group is in the range of 5:95 to 90:10. It is more preferred that the molar ratio of the at least one polysiloxane segment S2 and the ethylenically unsaturated group is in the range of 20:80 to 80:20. It is even more preferred that the molar ratio of the at least one polysiloxane segment S2 and the ethylenically unsaturated group is in the range of 70:30 to 30:70 and most preferred that the molar ratio is in the range of 40:60 to 60:40.

The molecular weight of the polyester segment S1 is suitably in the range of 200 to 10000 g/mol. More suitably, the molecular weight of the polyester segment is in the range of 300 to 8000 g/mol and even more suitably in the range of 500 to 4000 g/mol. The number and weight average molecular weight can be determined by gel permeation chromatography (eluent: tetrahydrofuran, standard: polystyrene, column temperature: ambient) according to DIN 55672 part 1 (year: 2016).

Suitably, the polymer comprises the polyester segment S1 in an amount between 10% to 95% by weight, calculated on the weight of the segments S1 and S2. More suitably, the polymer comprises the polyester segment S1 in an amount between 50 to 90% by weight, even more suitably in an amount between 20 to 85% by weight, calculated on the weight of the segments S1 and S2.

It is preferred that the polymer comprises the polysiloxane segment S2 in an amount between 5 and 90% by weight, calculated on the total weight of the segments S1 and S2. It is more preferred that the polymer comprises the polysiloxane segment S2 in an amount between 10 to 90% by weight, and even more preferred between 15 to 80% by weight, calculated on the total weight of the segments S1 and S2.

The polysiloxane segment S2 of the polymer generally comprises alkyl and/or aryl groups covalently linked to the Si atom. Preferred are alkyl groups with 1 to 30 carbon atoms. More preferred are alkyl groups with 1 to 18 carbon atoms and even more preferred with 1 to 8 carbon atoms.

Suitable examples for such alkyl and/or aryl groups are phenyl groups, phenyl groups substituted with one or more methyl groups, methyl groups, ethyl groups, propyl groups, butyl groups, pentyl groups, hexyl groups, heptyl groups, octyl groups, and the like as well as mixtures thereof.

In a preferred embodiment, the polysiloxane segment S2 is a polydimethylsiloxane segment. Polydimethylsiloxanes have repeating units of the chemical formula —[Si(CH₃)₂O]ₙ— where n is the number of repeating units.

The polymer comprises generally 1 to 20 polysiloxane segments S2. It is preferred that the polymer comprises 2 to 15 polysiloxane segments S2 and it is even more preferred that the polymer comprises 3 to 10 polysiloxane segments S2 and it is the most preferred that the polymer comprises 3 to 5 polysiloxane segments S2. The polysiloxane segments may be linked laterally and/or terminally to the polymer backbone. When the polysiloxane segment is linked terminally to the backbone, the segment is bound to an end group of the polyester backbone.

The number average molecular weight of the polysiloxane segment S2 is suitably in the range of 200 to 8000 g/mol, more suitably in the range of 300 to 5000 g/mol. Most suitably, the number average molecular weight of the polysiloxane segment is in the range of 500 to 3000 g/mol. The number and weight average molecular weight can be determined by gel permeation chromatography (eluent: toluene, standard: polydimethylsiloxane, column temperature: ambient) according to DIN 55672 (year: 2016).

The number average molecular weight of the polymer is preferably in the range of 500 to 100000 g/mol, more preferably 600 to 13000 g/mol and most preferably in the range of 1000 to 12000 g/mol.

The number and weight average molecular weight can be determined by gel permeation chromatography (eluent: tetrahydrofuran, standard: polystyrene, column temperature: ambient) according to DIN 55672 part 1 (year: 2016).

Preferably, the polymer is a comb polymer. A comb polymer has an essentially linear polymer backbone with at least two segments linked laterally to the polymer backbone.

Suitably, the polymer comprises at least three segments selected from S1 and S2. Preferably, at least two segments S1 are linked by one segment S2. In this embodiment, one segment S2 is bound laterally to one segment S1 with its one end, whereas it is bound to another segment S1 laterally or terminally with its other end.

In another embodiment, at least two segments S2 are linked by one segment S1. In this embodiment, one segment S2 is linked laterally to the S1 segment of the polymer backbone, whereas another segment S2 is linked terminally to the S1 segment of the polymer backbone. In a different embodiment, two segments S2 may be linked laterally to the S1 segment of the polymer backbone. In addition, further segments S2 may be linked laterally or terminally to the S1 segment of the polymer backbone.

Furthermore, the invention relates to a process for manufacturing the polymer according to the invention comprising the steps of
providing an ethylenically unsaturated polyester
providing a polysiloxane having at least one Si—H group
linking the polysiloxane covalently to the ethylenically unsaturated polyester via a hydrosilylation reaction.

Ethylenically unsaturated polyester, for example made by polycondensation of compounds having at least two hydroxyl groups and dicarboxylic acids, are reacted with polysiloxanes via a hydrosilylation reaction. Hydrosilylation describes the addition of Si—H bonds across ethylenically unsaturated bonds. Generally, the reaction is conducted catalytically. Different kind of catalysts may be used, for example platinum, Karstedt's catalyst, a lipophilic complex, or Wilkinson's catalyst, a coordination complex of rhodium. Preferably, a platinum catalyst is employed. During the hydrosilylation reaction, the polysiloxane is linked covalently to the ethylenically unsaturated polyester.

The polyester segment S1 is preferably prepared by the steps of
providing at least one compound having at least two ester-forming carbonyl groups
providing at least one compound having at least two hydroxyl groups
reacting the at least one compound having at least two ester-forming carbonyl groups and the at least one compound having at least two hydroxyl groups.

Suitably, the polyester segment S1 is provided by reacting compounds having ester-forming carbonyl groups with compounds having at least two hydroxyl groups. Generally, those compounds are dicarboxylic acids or tricarboxylic acids as already described above. During a polycondensation reaction of the dicarboxylic acids and the compounds having at least two hydroxyl groups, the polyester segment S1 is formed. Additionally, mono-ols may be used as well. Mono-ols, for example isoprenol, will lead to ethylenically unsaturated end groups of the polyester segment. Tri-ols may lead to hydroxyl pendant groups which are linked to the polyester segment S1. These hydroxyl groups can be modified by acetylation with acetic anhydride. The resulting ester group may be further modified by a transesterification reaction. For example, the acetic acid can be substituted by a long chain monocarboxylic acid. Thus, the polarity of the copolymer can be finetuned and adapted to the corresponding coating. By varying diols, triols and mono-ols, as well as di-, tri- and monocarboxylic acids the chain length and degree of branching may be adjusted. Moreover, ethylenically unsaturated end groups will result in terminally linked polysiloxane segments after hydrosilylation, whereas ethylenic unsaturation within the polymer backbone will lead to laterally bound polysiloxane segments. Thus, the polyester having unsaturation made by polycondensation reaction may include a broad variety of monomers with less restrictions. Therefore, liquid products with different functionalities can be obtained by selection of suitable monomers.

In a further embodiment the invention relates to the use of the polymer according to the invention as an additive for controlling the surface properties of an object.

Controlling the surface properties means the variation of the respective properties according to the intended use. Generally, the polymer is employed to modify surface properties to enhance the spreadability and slip, scratch resistance, anti-fingerprint, easy-to-clean properties and the avoidance of defects as well as obtaining surfaces without disrupting elements.

The objects may be coated with a liquid or solid coating composition. The coating composition is preferably liquid, especially if it comprises one or more diluents. The term “liquid” according to the present invention denotes a composition, being liquid at 23° C. and 100 kPa. Within the current invention, the term liquid refers to any liquid medium, independent of its viscosity. Liquids therefore comprise very low viscous media as well as high viscous media, such as paste materials.

The polymer of the invention is very suitable to control surface properties in liquid compositions, such as: a coating composition, a clear coat composition, a plastic formulation, a pigment paste, a polymer formulation, a sealant formulation, a cosmetic formulation, a homecare or industrial care formulation, a flooring formulation, a composition for the manufacture of electrical components and circuits.

Further coating compositions wherein the polymer according to the present invention may be used are solvent-based or solvent-free paints or lacquers.

Suitable objects are all three-dimensional objects, irrespective of their size and volume and whether they are mobile or immobile.

In a further aspect the invention relates to a composition comprising
the polymer according to the invention and
one or more diluents
   wherein the amount of the one or more diluents is between 0.1 and 95.0% by weight calculated on the total weight of the polymer and the one or more diluents.

The one or more diluents may be any organic compounds, which are capable of reducing the viscosity of the composition. The diluents include volatile organic diluents as well as non-volatile organic diluents. Examples of suitable diluents include diluents based on esters, ketones and hydrocarbons such as acetone, ethyl acetate and mixtures thereof.

Preferably, the amount of the one or more diluents is between 5 to 95%, more preferably between 5 to 30% and even more preferably between 10 to 20% by weight, calculated on the total weight of the polymer and the one or more diluents.

In a preferred embodiment, the composition according to the invention comprises a film-forming binder. Suitably the composition is a non-aqueous composition. In a further embodiment, the composition is an aqueous composition. Film-forming binders which may be employed may be any of those known in the prior art, preferably those which crosslink during a curing process. A crosslinking can take place by means of polyaddition, polycondensation, or polymerization reactions. Preferred curing processes are selected from radical or ionic polymerization reactions and polyaddition reactions. Preferably, the film-forming binder is selected from the group of epoxy resins, isocyanate systems, silyl modified polymers, acrylic polymers and saturated and unsaturated polyester resins. In a different embodiment, the composition does not comprise a film-forming binder.

A non-aqueous composition is essentially free from water. That denotes a solid composition or a liquid composition suitably comprising between 0.0 and less than 10.0% by weight of water, preferably between 0.0 and 7.0% by weight of water, calculated on the total weight of the non-aqueous composition. More preferably, the non-aqueous composition comprises less than 5.0% by weight of water. For example, the non-aqueous composition comprises less than 3.0% by weight or less than 1.0% by weight of water, calculated on the total weight of the non-aqueous composition.

The composition may further comprise customary additives. Examples of additives are antiblocking agents, stabilizers, antioxidants, pigments, wetting agents, dispersants, emulsifiers, rheology additives, UV absorbers, free-radical scavengers, waxes, nanoparticles, film-forming auxiliaries, and flame retardants.

The invention is illustrated further below giving reference to examples. The choice of the respective reaction conditions, as e.g., the reaction temperature, reaction time and dosing rates are known to the skilled person and are illustrated in more detail in the working examples.

### EXPERIMENTAL PART

### Synthesis Examples of Unsaturated Polyesters

### Example 1 PE 1

Succinic anhydride (309.34 g, 3.09 mol), trimethylolpropane allyl ether (269.35 g, 1.54 mol), hydroquinone (0.51 g, 0.005 mol) and 80 g toluene were charged to a 1000 ml three-neck reaction kettle equipped with mechanical stirrer, condensate trap, thermometer and nitrogen inlet. Additional toluene was used to fill the condensate trap. The temperature was increased to 120° C. and kept under stirring for 30 min. The temperature was then reduced to 90° C. and glycerol (170.80 g, 1.85 mol) and 0.1 g of the catalyst K-Kat XK-635 were added. The temperature was then increased to 190° C. within 5 hours and held at this temperature for further 5 hours. The stirring was continued under vacuum until an acid value below 8 mg KOH/g was achieved.

### Example 2 PE 2

Succinic anhydride (296.622 g, 2.96 mol) and 3-methylbut-3-en-1-ol (255.30 g, 2.72 mol) and 35 g toluene were charged to a 1000 ml three-neck reaction Kettle equipped with mechanical stirrer, condensate trap, thermometer and nitrogen inlet. Additional 3-methylbut-3-en-1-ol was used to fill the condensate trap. The temperature was increase to 120° C. and kept under stirring for 30 min. After that the following components were added in the following order Hydroquinone (8.89 g, 0.089 mol), 2,2-dimethyl-1,3-propandiol (30.87 g, 0.30 mol), 2-methyl-1,3-propandiol (40.07 g, 0.44 mol), 0.1 g of the catalyst K-Kat XK-635 and finally glycerol (86.24 g, 0.74 mol) were added. The temperature was then increased to 190° C. within 6 hours and held at this temperature for further 5 hours. The rection mixture was cooled down to 120° C. and vacuum was applied. The stirring was continued under vacuum and at temperatures up to 160° C. until an acid value below 8 mg KOH/g was achieved.

### Example 3 PE 3

Succinic anhydride (283.72 g, 2.83 mol), trimethylolpropane allyl ether (98.80 g, 0.57 mol), hydroquinone (0.51 g, 0.005 mol) and 80 g xylene were charged to a 1000 ml three-neck reaction kettle equipped with mechanical stirrer, condensate trap, thermometer and nitrogen inlet. Additional Xylene was used to fill the condensate trap. The temperature was increased to 90° C. and kept under stirring for 30 min before 2-dimethyl-1,3-propandiol (127.00 g, 1.22 mol), 2-methyl-1,3-propandiol (109.87 g, 1.22 mol), and 0.1 g of the catalyst K-Kat XK-635 were added. The temperature was continuously increased. A temperature of 190° C. was reached within 5 hours and the reaction mixture was stirred at this temperature for further 5 hours. The reaction mixture was then cooled down to 140° C. and vacuum was applied. The volatile part was evaporated under reduced pressure and at temperatures up to 160° C. Stirring at 160° C. was continued under vacuum until an acid value below 8 mg KOH/g was achieved.

The reaction temperature was then reduced to 90° C. before 100 ml Xylene and methane sulfonic acid (0.2 g, 2 mmol) were added. Acetic anhydride (35 g, 0.34 mol) was added dropwise. The stirring at 90° C. was continued for 4 h. All volatile components were then removed by distillation under vacuum at 130° C. 30 g Xylene were added and removed under the same condition. This procedure was repeated for one more time.

### Example 4 PE 4

Succinic anhydride (321.82 g, 3.22 mol), trimethylolpropane allyl ether (112.07 g, 0.64 mol), hydroquinone (0.78 g, 0.007 mol) and 80 g xylene were charged to a 1000 ml three-neck reaction kettle equipped with mechanical stirrer, condensate trap, thermometer and nitrogen inlet. Additional Xylene was used to fill the condensate trap. The temperature was increased to 90° C. and kept under stirring for 30 min before 2-dimethyl-1,3-propandiol (110.52 g, 1.06 mol), 2-methyl-1,3-propandiol (95.63 g, 1.06 mol), and 0.1 g of the catalyst K-Kat XK-635 were added. After 30 min stirring at 90° C. glycerol (59.22 g, 0.64 mol) was added. The temperature was continuously increased. A Temperature of 190° C. was reached within 8 hours and the reaction mixture was stirred at this temperature for further 5 hours. The reaction mixture was then cooled down to 140° C. and vacuum was applied. The volatile part was evaporated under reduced pressure and temperatures up to 160° C. The stirring was continued under reduced pressure at 160° C. until an acid value below 8 mg KOH/g was achieved.

The reaction temperature was then reduced to 90° C. before 100 ml Xylene and methane sulfonic acid (0.2 g, 2 mmol) were added. Acetic anhydride (35 g, 0.34 mol) was added dropwise under stirring. The stirring at 90° C. was continued for 4 h. All volatile components were the removed by distillation under vacuum at 130° C. 30 g Xylene were added and removed by evaporation under the same conditions. This procedure was repeated one more time.

TABLE 1
Properties of the unsaturated polyesters

| | Example 1 | Example 2 | Example 3 | Example 4 |
|---|---|---|---|---|
| Property | PE 1 | PE 2 | *PE 3 | PE 4 |
| Acid value [mg KOH/g] | 5.3 | 3.0 | 6.7 | 3.1 |
| Iodine value [g/100 g] | 54.4 | 119.0 | 25.4 | 24.5 |
| Viscosity [mPa · s] | 8325 (at | 130 (at | 20599 (at | 5649 (at |
| | 80° C.) | 20° C.) | 80° C.) | 80° C.) |
| Mn | 3434 | 541 | 3762 | 3887 |
| Mw | 41162 | 905 | 41149 | 11272 |
| Appearance | Yellowish | Yellowish | Yellowish | Yellowish |
| | liquid | liquid | viscos | (turbid) |
| | | | liquid | viscos |
| | | | | liquid |

### General Procedure for the Preparation of SiH-Functional Precursors SM1, SM2 and SM3

Si-functional precursors were prepared according to table 2 and as described in the following paragraph:

A four-necked flask provided with stirrer, thermometer, dropping funnel and nitrogen inlet tube is heated to 150° C. under nitrogen flow using a heat gun to remove traces of water. After cooling of the apparatus to ambient temperature under nitrogen flow, the vessel is charged with a solution of hexamethylcyclotrisiloxane (D3) in cyclohexane, which has been dried over molecular sieve A3 for 24 h. At a reaction temperature of 35° C., the butyllithium solution (1.7M in hexane) was added dropwise over a period of 5 min. The reaction mixture was not allowed to exceed 41° C. by cooling with a water bath. After 10 min at 40° C., Tetrahydrofuran (THF) was slowly added to start the polymerization reaction. The temperature was monitored and kept below 40° C. After 5 h, the reaction was quenched by the addition of Dimethylchlorosilane and stirred for additional 30 min. Afterwards, the mixture was neutralized by the addition of a Sodium bicarbonate solution in water (9.0 wt.-%) and vigorously stirred for 30 min. The organic layer was separated, heated under vacuum (20 mbar at 100° C.) to remove all solvents completely and filtered through a plug of Celite. The product (unsymmetrical, SiH-functional Polydimethylsiloxane) is a clear, colorless liquid of low viscosity.

TABLE 2
Raw materials for the preparation of SiH-
functional precursors SM1, SM2 and SM3

| | SM1 | SM2 | SM3 |
|---|---|---|---|
| | (500 | (1000 | (2000 |
| Raw material | g/mol) | g/mol) | g/mol) |
| Hexamethylcyclotrisiloxane D3 | 138.49 | 319.01 | 679.65 |
| [g] | | | |
| Cyclohexane [g] | 111.47 | 256.77 | 547.05 |
| Butyllithium (1.7M in hexane) [g] | 100.00 | 100.00 | 100.00 |
| Tetrahydrofuran [g] | 111.47 | 256.77 | 547.05 |
| Dimethylchlorosilane [g] | 37.73 | 37.73 | 37.73 |
| Sodium bicarbonate solution (9 | 38.90 | 38.90 | 38.90 |
| wt.-% in water) [g] | | | |

Analytical data

| | | | |
|---|---|---|---|
| Si—H equivalent weight average | 439.50 | 834.50 | 1711.00 |
| [g/mol] | | | |
| Mn | 572 | 1065 | 2108 |
| Mw/Mn | 1.12 | 1.24 | 1.20 |

### General Procedure for the Preparation of Polyester-Polysiloxane Copolymers

Copolymers were prepared according to table 3 and as described in the following paragraph:

A four-necked flask provided with stirrer, thermometer, dropping funnel and nitrogen inlet tube is charged with the ethylenically unsaturated polyester and the SiH-functional precursors according to table 3. The components are mixed, and nitrogen is passed over the mixture throughout the reaction. After the reaction temperature has been increased to 60° C. the catalyst (2 wt.-% Karstedt's catalyst in Xylene) is charged into the vessel. The reaction temperature is increased to 80° C. and held at this temperature and the conversion of SiH was monitored via the Si—H equivalent weight average measurement until an Si—H-conversion above 98% was achieved. The solvent was evaporated under vacuum at 110° C.

TABLE 3
Raw materials and analytical data for the preparation of polyester-polysiloxane copolymers

| Raw material | | | | | | | |
|---|---|---|---|---|---|---|---|
| [parts by | | | | | | | |
| weight] | SMPE 1 | SMPE 2 | SMPE 3 | SMPE 4 | SMPE 5 | SMPE 6 | SMPE 7 |
| SM 1 | | | | | 26.600 | | |
| SM 2 | | | 26.300 | 11.200 | | 58.400 | 54.600 |
| SM 3 | 11.100 | 5.100 | | | | | |
| PE 1 | 11.000 | 11.800 | 12.000 | 5.400 | | | |
| PE 2 | | | | | 26.400 | 12.500 | 12.600 |
| *PE 3 | | | | | | | |
| PE 4 | | | | | | | |
| Di-functional | | | | 0.300 | | | |
| hydride | | | | | | | |
| terminated | | | | | | | |
| PDMS (DMS- | | | | | | | |
| H11, Gelest | | | | | | | |
| Inc.) (eq. | | | | | | | |
| weight 450 | | | | | | | |
| g/mol) | | | | | | | |
| Acetone/ethyl | 77.800 | | | | | | |
| acetate (1:4) | | | | | | | |
| Acetone/ethyl | | 83.000 | | | | | |
| acetate (1:6) | | | | | | | |
| Acetone/ethyl | | | 61.500 | | | | |
| acetate (1:3) | | | | | | | |
| Ethyl acetate | | | | 83.000 | 46.800 | 28.700 | 32.400 |
| 0.005% | 0.100 | 0.100 | 0.200 | 0.100 | 0.200 | 0.400 | 0.400 |
| Karstedt | | | | | | | |
| catalyst | | | | | | | |
| solution in | | | | | | | |
| Xylene | | | | | | | |

Analytical data

| | | | | | | | |
|---|---|---|---|---|---|---|---|
| MW | 15462 | 50666 | 156811 | 151151 | 1498 | 3918 | 2923 |
| Mn | 3863 | 4859 | 9729 | 10237 | 875 | 2339 | 1810 |
| MW/Mn | 4.00 | 10.43 | 16.12 | 14.77 | 1.71 | 1.68 | 1.61 |
| Appearance | Slimy | Slimy | Clear | Clear | Clear | Clear | Turbid |
| | turbid | turbid | yellow | amber | amber | Yellow | amber |
| | liquid | liquid | liquid | liquid | liquid | liquid | liquid |

TABLE 4
Raw materials and analytical data for the
preparation of PDMS polyester copolymers:

| Raw material | *SMPE | SMPE | *SMPE | SMPE |
|---|---|---|---|---|
| [parts by weight] | 9 | 10 | 11 | 12 |
| SM 1 | 13.900 | 13.800 | | |
| SM 2 | | | | |
| SM 3 | | | 36.100 | 36.900 |
| PE 1 | | | | |
| PE 2 | | | | |
| *PE 3 | 48.000 | | 31.200 | |
| PE 4 | | 46.000 | | 30.700 |
| Ethyl acetate | 37.700 | | 32.500 | |
| 0.005% Karstedt | 0.400 | 0.500 | 0.200 | 0.200 |
| catalyst solution | | | | |
| in Xylene | | | | |
| Xylene | | 39.700 | | 32.200 |
| MW | 16070 | 69469 | 20060 | 54270 |
| Mn | 5300 | 6003 | 6909 | 6117 |
| MW/Mn | 3.00 | 11.50 | 2.90 | 8.90 |
| Appearance | Brown, | Yellow, | Turbid | Milky, |
| | liquid | liquid | amber | viscos |
| | | | liquid | liquid |

### Example 5 (SMPE 8)

Polyester PE4 (44.060 g), poly dimethyl siloxane SM 1 (8.820 g) and 88.000 g xylene were charged to a 250 ml four-neck round bottom flask equipped with mechanical stirrer, cooler, thermometer and stopper for the fourth neck. The temperature was increased to 60° C. Once the temperature was reached, Karstedt catalyst (0.300 g of a 0.005 w.-% in xylene) was added. The temperature was increased to 80° C. The reaction was monitored via Si—H equivalent weight average of the silicone. When hydrosilylation reaction was completed methacrylic anhydride (4.010 g), methyl hydroquinone (0.004 g) and p-benzoquinone (0.100 g) were added. The temperature was increased to 100° C. Once the temperature was reached methane sulfonic acid (0.060 g) was added. The reaction was controlled by ¹H-NMR using diffusion filter. After 8 h at 100° C. the rection was completed. The volatile components were removed under vacuum at 100° C.

### Si—H Equivalent Weight Average:

The equivalent weight average of SiH-functional precursors such as of the SiH-functional precursors SM1 to SM3 disclosed in the experimental part and the SiH-conversion during the hydrosilylation reaction for the preparation of the macromonomer precursors is determined according to DIN 53241-1 via volumetric measurement of H₂.

### Iodine Value:

The iodine number is the quantity of halogen in g iodine that is accumulated to 100 g of the sample. The iodine value was measured according to Kaufmann method. Bromine is added to the double bonds in the unsaturated fats in the dark. The excess bromine is reduced with iodide and the amount of iodine formed is determined by titration with sodium thiosulfate solution.

### Acid Value:

The acid value is the KOH quantity in mg that is required for neutralizing 1 g of substance. The acid values were determined by a neutralization reaction with a 0.1 N KOH in Ethanol according to DIN EN ISO 2114.

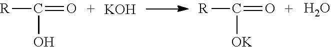

### Viscosity:

The viscosity was measured by using rotational viscosimeter Haake Roto Visko 1 with Peltier thermo-module. Cone-plate measuring system C35/1° Ti gap 0,050 mm. Software Haake RheoWin.

### Application Tests

TABLE 5
Formulation of coating system 1

| Material | Parts in wt.-% |
|---|---|
| Setalux 1756 VV65, Allnex | 60.0 |
| Setamine US138 BB, Allnex | 24.0 |
| Shellsol A, Shell Chemicals Europe | 4.0 |
| Solvesso 150 ND, ExxonMobil Chemical | 4.0 |
| Xylene | 8.0 |
| Total | 100.0 |
| Additive (SMPE 1-SMPE 12) | X |

TABLE 6
Formulation of coating system 2

| Material | Parts in wt.-% |
|---|---|
| Laromer PE 44F | 37.5 |
| Laromer PE 56F | 15.9 |
| Dipropylene glycol diacrylate | 32.2 |
| Isobornyl acrylate (IBOA) | 11.4 |
| Irgacure 500 | 3.0 |
| Total | 100 |
| Additive (SMPE 8-SMPE 12) | X |

### Coating Preparation:

The coating was prepared by mixing the ingredients using a dispersing disc of 10 cm in diameter for 10 min with 2500 rpm at room temperature. As inventive additive examples, SMPE 1 to SMPE 12 were used respectively as synthesized. The amount (X) of the respective additive is given in table 7 to 10 in weight-%, based on the total weight of the preparation without additive.

### Application for Coating System 1:

A 100×200 mm glass plate substrate (metal panel 21.0×29.7 cm was used instead of glass for the migration test) was cleaned with ethanol and the liquid coating formulation was applied via a 50 μm gap doctor blade. The applied films were put horizontally for 15 min at room temperature. The plates were then heated to 140° C. for 25 min for curing.

### Application for Coating System 2:

A 100×200 mm glass plate substrate was cleaned with ethanol and the liquid coating formulation was applied via a 50 μm gap doctor blade. The curing was caried out on UV-bank with Hg-Lampe 120 W/cm and 5 m/min.

### Recoatability Test:

The recoatability test was made by recoating the glass plate as described above with the same coating system but without addition of the inventive additive example. The appearance of the new coating layer was then visually evaluated according to leveling and crater formation.

### Coefficient of Friction Measurement:

The coefficient of friction was determined by measuring the force, which is needed for moving a weight of 500 g placed on a round platelet of felt with a constant velocity of 50 mm/sec over a coated panel for 3 seconds. The reduction of surface slip is calculated by comparing the coefficient of friction from a panel with a modified coating (inventive additive example) against a panel coated with an unmodified coating (control, non-inventive example) in percent (%).

### Surface Tension:

The surface tension was measured by using the du Noüy ring method. A ring is slowly lifted from the surface of the liquid. The force, F, required to raise the ring from the liquids surface is measured and related to the liquid's surface tension γ.

$$F = {w}_{( ring )} + 2 π ( + {r}_{a} ) \cdot γ$$

where rᵢ is the radius of the inner ring of the liquid film pulled and rₐ is the radius of the outer ring of the liquid film. w_{(ring)} is the weight of the ring minus the buoyant force. The values are absolute values in mN/m.

### Marker and Permanence of Marker Test:

The marker test was conducted by using a permanent marker (Edding® permanent marker 3000). A 5 cm long line was drawn on the coating surface. The surface was wiped with a dry lab paper tissue. The results were visually evaluated, in which the easy-to-clean property was given grades from 1-5. The value 1 means very good, the line was removed without any trace and 5 means no easy-to-clean property, the line is unchanged in color and intensity. The permanence test was conducted by wiping the surface with 100 double strokes using a cloth fixed on the dull side of a 390 g hammer and soaked with a solvent (ethanol or xylene as described in table 8).

### Migration Test:

A panel coated with coating system 1 according to the described method above was cut in 9×9 cm pieces. Ten of these pieces were stacked, so that the coated side and the uncoated side were put on each other. The panel stack was pressed by a force of 20 N by using a screw clamp and put in the oven at 60° C. for 24 h.

The uncoated side was coated with the same coating system without the addition of an inventive additive example (control) and the leveling and crater formation were visually evaluated and expressed as appearance value. An appearance value of 1 means very good and 5 means very poor.

TABLE 7
Leveling and cratering tests in coating system 1:

| | Additive | | | Surface | Coefficient |
|---|---|---|---|---|---|
| | [% by | | | tension | of |
| Sample | weight] | Cratering | Leveling | [mN/m] | friction |
| Control | 0.00 | 2-3 | 3 | 28.24 | 0.370 |
| SMPE 1 | 0.05 | 1 | 2 | 23.42 | 0.010 |
| SMPE 1 | 0.20 | 1-2 | 2 | 23.62 | 0.010 |
| SMPE 2 | 0.05 | 1 | 1 | 24.82 | 0.005 |
| SMPE 2 | 0.20 | 1 | 1-2 | 23.73 | 0.005 |
| SMPE 3 | 0.05 | 1 | 1-2 | 25.45 | 0.020 |
| SMPE 3 | 0.20 | 1 | 1-2 | 24.43 | 0.030 |
| SMPE 5 | 0.05 | 1 | 1 | 29.06 | 0.150 |
| SMPE 5 | 0.20 | 1-2 | 1 | 28.71 | 0.060 |
| SMPE 6 | 0.05 | 1 | 1 | 25.07 | 0.010 |
| SMPE 6 | 0.20 | 2 | 1 | 25.33 | 0.010 |
| SMPE 7 | 0.05 | 1-2 | 1 | 25.98 | 0.010 |
| SMPE 7 | 0.20 | 1-2 | 1 | 24.75 | 0.010 |
| SMPE 4 | 0.05 | 1 | 1 | 24.22 | 0.040 |
| SMPE 4 | 0.20 | 2 | 1-2 | 23.40 | 0.020 |

Leveling and cratering were evaluated by visual estimation, in which the appearance was given grades from 1 (very good)-5 (very poor).

It can be seen from table 7 that the inventive application examples comprising SMPE 1 to SMPE7 provided highly improved surface properties compared to the non-inventive application example (control).

TABLE 8
Easy-to-clean test (marker test/permanence test) in coating system 1

| | | | | | | Permanence | Permanence |
|---|---|---|---|---|---|---|---|
| | Pendant | Additive | Surface | | | of marker | of marker |
| | functional | [% by | tension | Coefficient | Marker | test | test |
| Sample | group | weight] | [mN/m] | of friction | test | with ethanol | with xylene |
| *Control | — | 0.0 | 28.89 | 0.500 | 5 | 5 | 5 |
| *SMPE | — | 0.1 | 25.98 | 0.020 | 5 | 5 | 5 |
| 11 | | | | | | | |
| *SMPE | — | 0.5 | 23.79 | 0.010 | 5 | 5 | 5 |
| 11 | | | | | | | |
| *SMPE | — | 1.0 | 23.31 | 0.010 | 5 | 5 | 5 |
| 11 | | | | | | | |
| SMPE 12 | —OH | 0.1 | 25.09 | 0.015 | 1 | 1 | 1 |
| SMPE 12 | —OH | 0.5 | 23.95 | 0.015 | 1 | 1 | 1 |
| SMPE 12 | —OH | 1.0 | 23.73 | 0.015 | 1 | 1 | 1 |

The * indicates that the example is a non-inventive example.

It can be seen from table 8 that the inventive examples show excellent easy-to-clean properties whereas the non-inventive examples lead to the same results which are obtained using the control without the addition of additives.

TABLE 9
Recoatability and migration test in coating system 1

| | | | | | | Recoatability | | |
|---|---|---|---|---|---|---|---|---|
| | | | | | | Coefficient | | |
| | | | | | | of | | Appearance |
| | Pendant | Additive | | | Coefficient | friction | Appearance | after |
| | functional | [% by | | | of | after | after | migration |
| Sample | group | weight] | Levelling | Cratering | friction | recoating | recoating | test |
| *Control | | 0.0 | 1 | 2 | 0.50 | 0.55 | 1 | 1 |
| *SMPE 9 | — | 0.1 | 1 | 1 | 0.30 | 0.25 | 2 | 2 |
| SMPE 10 | —OH | 0.1 | 1 | 1 | 0.48 | 0.55 | 1 | 1 |

The * indicates that the example is a non-inventive example.

Usually, the addition of siloxanes leads to a reduced recoatability. The comparison between the inventive and non-inventive examples in table 9 shows that the inventive example SMPE 10, containing a pendant functional hydroxy group does not reduce the recoatability even though the crater formation was inhibited.

The migration test is made in order to simulate a one-side coil coating, in which the coating is applied on a metal strip in a continuous process and subsequently cured. The warm strip is rolled as a coil and the coated side and uncoated sides hit on to each other. The uncoated side can then be coated after the formation for the different applications. The following coating process shall not be adversely influenced by traces of additive on the uncoated side.

The table above shoes that the inventive example with a pendant hydroxy group does not influence the coating process of the second uncoated metal surface which means that the additive is anchored in the coating matrix via the pendant functional groups and no migration is taking place.

TABLE 10
Recoatability test in coating system 2

| | | | | | Recoatability | |
|---|---|---|---|---|---|---|
| | | | | | Coefficient | |
| | | | | | of | |
| | Pendant | Additive | Surface | Coefficient | friction | Appearance |
| | functional | [% by | tension | of | after | after |
| Sample | group | weight] | [mN/m] | friction | recoating | recoating |
| *Control | | 0.0 | 33.78 | 0.62 | 0.68 | 1 |
| *SMPE 9 | — | 0.1 | 28.43 | 0.34 | 0.66 | 2 |
| *SMPE 9 | — | 0.5 | 25.45 | 0.19 | 0.58 | 4 |
| SMPE 8 | —O—(C═O)C(CH₃)═CH₂ | 0.1 | 29.68 | 0.38 | 0.65 | 1 |
| SMPE 8 | —O—(C═O)C(CH₃)═CH₂ | 0.5 | 28.11 | 0.19 | 0.65 | 2 |

The * indicates that the example is a non-inventive example.
The results were evaluated visually. Appearance 1 means crater free and very good leveling. Appearance 5 means crater formation or poor leveling.

The comparison between the inventive and non-inventive examples in table 10 shows that the inventive example SMPE 8, containing a pendant functional methacrylate group does not reduce the recoatability even though the surface tension and the coefficient of friction were reduced. The coefficient of friction value of the new coating layer becomes similar to the non-inventive control. In sum inventive examples with methacrylic function exhibit the desired properties expected from silicone containing additive without to negatively influence the recoatability.

1. A polymer comprising
i) a polymer backbone comprising a polyester segment S1, which comprises at least one unit according to formula (I) 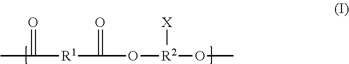
wherein
R¹ is an aromatic or aliphatic, saturated or unsaturated group consisting of elements selected from C, H, O,
R² is an aromatic or aliphatic, saturated or unsaturated group consisting of elements selected from C, H, O,
X comprises at least one of —OH, —(C═O)OH, —O—(C═O)CH₃, —O—(C═O)C(CH₃)═CH₂ and —O—(C═O)CH═CH₂,
wherein the polyester segment S1 comprises at least one ethylenically unsaturated group, which is different from X, and
ii) at least one polysiloxane segment S2.

2. The polymer according to claim 1, wherein the molar ratio of the at least one polysiloxane segment S2 and the ethylenically unsaturated group is in the range of 5:95 to 50:50.

3. The polymer according to claim 1, wherein the polymer comprises at least three segments selected from S1 and S2.

4. The polymer according to claim 1, wherein the polyester segment S1 is obtainable by reacting compounds having at least two hydroxyl groups and dicarboxylic acids.

5. The polymer according to claim 1, wherein R¹ is a hydrocarbyl group or a hydrocarbyl group interrupted by one or more ether groups and R² is a hydrocarbyl group.

6. The polymer according to claim 1, wherein the polymer comprises the polyester segment S1 in an amount between 10% and 95% by weight calculated on the weight of the segments S1 and S2.

7. The polymer according to claim 1, wherein the polysiloxane segment S2 comprises at least one of an alkyl and an aryl group covalently linked to the Si atom.

8. The polymer according to claim 1, wherein the polymer comprises 1 to 20 polysiloxane segments S2.

9. The polymer according to claim 1, wherein the polysiloxane segment S2 is a polydimethylsiloxane segment.

10. The polymer according to claim 1, wherein the number average molecular weight of the polysiloxane segment S2 is in the range of 200 to 8000 g/mol.

11. The polymer according to claim 1, wherein the polymer is liquid at 23° C. and 100 kPa.

12. (canceled)

13. A composition comprising
the polymer according to claim 1
one or more diluents
wherein the amount of the one or more diluents is between 0.1 and 95.0% by weight calculated on the total weight of the polymer and the one or more diluents.

14. The composition according to claim 13, wherein the composition further comprises a film-forming binder.

15. A method of controlling surface properties of an object comprising applying a composition to a surface of the object wherein the composition comprises the polymer according to claim 1.
